(19) United States
(12) Patent Application Publication
(10) Pub. No.: US 2012/0036026 A1
(43) Pub. Date: Feb. 9, 2012

(54) Novel system for digital content publishing, distribution, and management

(75) Inventor: Dmitry Yankelevich, Moreland Hills, OH (US)

(73) Assignee: VISITOR DAY, LLC, Moreland Hills, OH (US)

(21) Appl. No.: 12/930,819

(22) Filed: Jan. 18, 2011

Related U.S. Application Data
(60) Provisional application No. 61/336,186, filed on Jan. 19, 2010.

(51) Int. Cl. G06Q 30/02; G06F 15/16

(52) U.S. Cl. 705/14.73; 709/203

(57) ABSTRACT

The present invention provides all necessary tools and procedures to a) automatically create fully functional Websites in place of Parked domains, b) allow bloggers and other Publishers to create and distribute content across such Websites.

### I. FIELD OF THE INVENTION

The present invention relates generally to distribution of digital content, and more specifically to publishing, distribution and management of Articles over the Internet.

### II. BACKGROUND ART

Domain Owners:

Internet users often bypass Search Engines and browse by way of Direct Navigation. The heart and soul of Direct Navigation is Internet address (URL) which Internet user types into their browser while looking for subject of interest. This address is called the Domain Name or simply the Domain. Currently, there are over 150,000,000 of such domains registered worldwide by corporations, organizations, governments, and individuals.

Over 20% of these domains (30,000,000) belong to Domain Investors. These corporate entities and individuals register domains for the purpose of reselling them later to interested end users. For example Volkswagen could purchase Hybrid.com, Intel could purchase PC.com, and Microsoft could purchase GPS.com

Typical Domain Investor (a domainer) will have from 500 to several thousand domains in their portfolio and will try to generate profit from every domain they own while waiting for the right offer.

However, because of the large size of their portfolios, it is highly impractical for domainers to develop and manage their domains. Thus, they forward their domains to management companies which monetize on their domains for them, charging certain management fee.

Such service provided by management companies is called ‘Parking’ service. Examples of parking services include sedo.com, fabulous.com, parked.com, godaddy.com, etc.

However, while the owner of, for example, Map.com is waiting for an offer from, for example, MapQuest to purchase his domain, the undeveloped (Parked, dormant) domain consists of almost no useful content and really is just a collection of Advertising links.

Because of lack of relevant quality content, parked (undeveloped) domains have very little attention from Search Engines resulting in lower traffic and consequently lower revenues for Domainers.

Internet Users are also frustrated with such concept of Domain management, as Parked (dormant) domains provide no useful content to visitors, just links to advertisers.

Thus, there needs to be a way for hands-free automatic development of domains and placing quality content on Domain pages.

Publishers:

Currently, majority of Internet Users find relevant information through Search Engines. Major Search Engines include Google, Yahoo, Bing, Ask, and others. All these Search Engines strive to display the Information which is the most relevant to search terms the Internet Users enter into the Search Engine's Search Box.

This Information is essentially the List of Sites which, according to Search Engine, have the most relevant information for the search terms (Keywords) the Internet User is searching for.

The Search Engines find and rate each and every Relevant Site according to a lot of different criteria. One of the most important criteria is how many other sites reference this Relevant Site. Such Reference is called Inbound Link and is essentially a hyperlink to the Site (i.e. http://www.site.com). The more qualified References the Relevant Site has, the more it is closer to the TOP of the List of Sites.

Search Engines closely monitor these References and evaluate their ‘weight’. The ‘weight’ is comprised of multiple factors: does this Reference come from the Site which itself has a lot of ‘good’ References pointed to it (has good Page Ranking (PR) in Google's terms), is there a lot of useful content around such Reference, is this content relevant to a searched Keyword, are there multiple copies of this content available elsewhere on the Internet, etc.

It's worth pointing out though, that each site is a collection of individual Pages and same rules apply to all these Pages. Most of Search Engines actually evaluate individual Pages and their relevance to the searched Keyword not only Sites. So here and thereafter, the term Site will mean not only actual site (site.com), but also an individual page on the site (site.com/page.html, site.com/page.aspx, page.site.com, etc.)

According to the above, Publisher of every Relevant Site wants as many ‘good’ References to their Site as possible. Such References are obtained mainly by two techniques. First—creation of useful content and publishing it on Relevant Site, which will attract visitors and then will entice them to share their thoughts about read content on multitude of other sites while REFERENCING the Relevant Site. Second—creation of useful content and publishing it on other sites while REFERENCING the Relevant Site. Such content is called an Article.

While First task is easy (Publisher has full control over their Relevant Site and its content), the Second is very challenging. Currently, there are numerous sites all over the internet that would allow Publishers to publish their Articles on their pages, however:
a) The price, rules, terms and conditions vary tremendously forcing Publisher to spend enormous amount of time searching for such sites, researching them, creating multiple accounts, publishing articles through diverse procedures, and finally attempting to manage their Articles.
b) Since from Search Engine Optimization (SEO) stand of point it's not desirable to post a lot of Articles on the same site (even if individual Pages differ), Publisher is forced to constantly look for more and more sites that would allow Article publishing, thus the whole process described in paragraph a) becomes increasingly unmanageable.
c) Each time when publishing on one of these sites, the Publisher has no way of determining whether they're going to be ‘rewarded’ or ‘punished’ by Search Engines for publishing their Article, because in a lot of cases Search Engines ‘black list’ such sites for ‘link spamming’ and it might actually hurt the Publisher to be published on such sites.
d) Even if such site is in good standing with Search Engines, the Page on which the published Article is displayed is usually a brand new page, with no prior history of indexing by Search Engines and virtually no inbound links. In majority of cases such new web page will have PR ‘0’. The Outbound Link from such page will have very little ‘weight’ for Search Engine and this is yet another reason the Publisher is forced to spend significant resources constantly posting new articles and keep looking for new sites that allow article posting.
e) And most importantly, distributing Articles through such sites, Publisher has no way tracking Article performance such as number of visits and clicks, or making the change to an Article in one place and affect all distributed copies of an Article.

Accordingly, there is a need for Centralized System which would allow a Publisher to Publish, Distribute, Manage, and Track Performance of all their Articles across multiple Sites from a single account. The system which would simplify and unify the process of Publishing (inputting an Article into the system), Distribution (searching for proper Sites (Pages) according to variety of criteria such as existing Traffic, PR, and others; scheduling an Article to be featured at desired Sites(Pages) and make payments, if needed), and Manage (edit Article, pause or discontinue Article publication; track Article performance (amount of visits to the Page, amount of clicks to the Article, etc.);)

The development of the present Invention fulfills this need by providing a novel System for digital content Publishing, Distribution, and Management.

### III. DISCLOSURE OF INVENTION

The present invention generally provides for Centralized System which would allow Publishers to Publish, Distribute, Manage, and track performance of all their Articles from a single account across multiple Sites;

The present invention provides tools and methods for Domain Owners to develop their dormant Domains (undeveloped sites (‘Parked’ domains) which do not have useful and relevant information for a visitor except of featured Advertisings) into Sites containing, besides Advertising, multiple pages of information relevant to visitors' interests and expectations (demand).

Such Sites can be developed by as little efforts as adding the Domain to Domain Owner's account within such Centralized System and forwarding DNS server for the Domain to Centralized System's servers.

Methods of such System allow Owners of Sites to approve/decline such Distribution of Articles on Pages of their Sites and to benefit from such Article Placement by a way of obtaining quality content for their Sites and optionally monetize from such content placement.

This is shown herein by one exemplary embodiment which involves Domain Owners (owners of otherwise undeveloped sites (‘Parked’ domains) that want to have useful and relevant content to be placed on their sites and get paid for such placement) and Publishers (owners of e-commerce Sites, online magazines, as well as Domains that want their Articles be published on Domains for the purpose of attracting targeted audience to their Sites as well as creating ‘good’ links for SEO purposes).

### IV. BRIEF DESCRIPTION OF THE DRAWING

The advantages and features of the present invention will become better understood with reference to the following more detailed description and claims taken in conjunction with accompanying drawings in which like elements are identified with like symbols, and in which:

FIG. 1 is a Flow Chart of Account Holders' activities within the System as well as main System Functions according to preferred embodiment;

### V. DESCRIPTION OF THE PREFERRED EMBODIMENT.

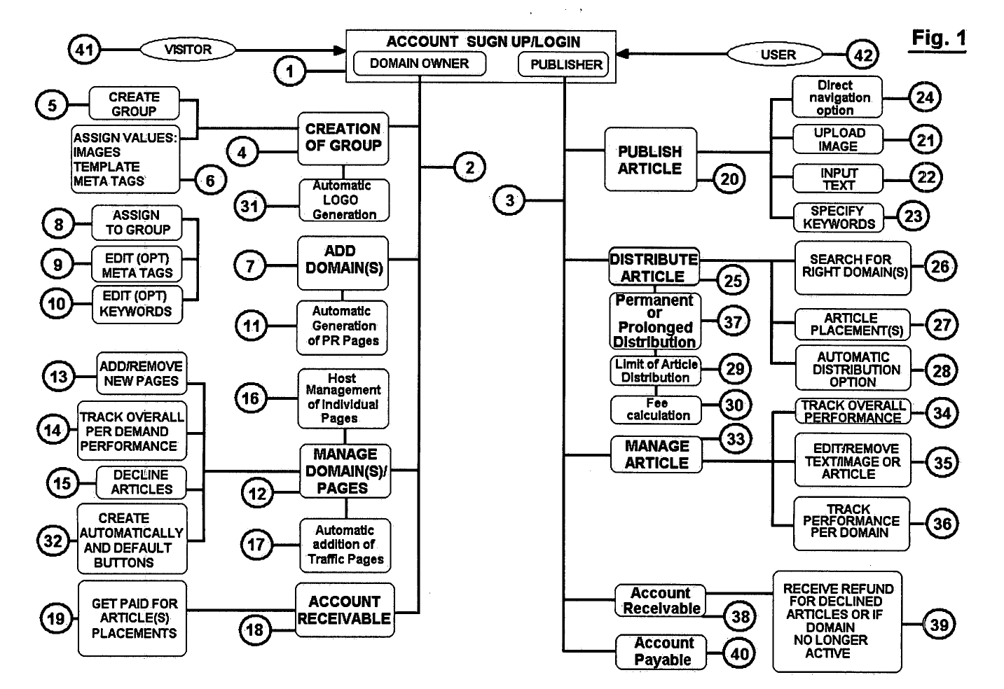

Referring now to FIG. 1, 1 is the main entrance to the System through which any Visitor 41 or User 42 can create and then use at least one User Account. Upon creation of account, the User can exercise either Domain Owner (Site Owner) Functionality 2 or Publisher Functionality 3. Through the use of 2, the User can:

Execute Creation of the Group 4 by Creating a Group 5 and Assigning certain Values to the Group 6 such as, by way of example and not as a limitation, Keywords, template, template color, template Images, and Group Meta Tags.

Automatic Logo Generation feature 31 allows automatically generate logo for each Domain based on, by way of example and not as a limitation, a Domain address (http://www.site.com), Keywords or Categories specified for Group of Domains or a Single Domain, the choice of Group or Domain Template, geography of the incoming traffic, etc. Later, Domain Owner can adjust the logo to allow more perfect fit for every Domain. The Logo generation will consist of, by way of example and not as a limitation, automatically choosing the shape, color theme or image, size, shrift and animation.

Then the User can Add Domains 7 and while adding, change such values for each individual domain, by way of example and not as a limitation, as the Group it should be Assigned to 8, Meta Tags 9, and Domain Keywords 10. If not edited, the above value will stay the same as in the Group a domain belongs to.

While the User is adding domains to the Group, the System researches each Domain's history (through for example archive.org) and automatically adds those pages to a Domain that deem useful or of value (for example those pages that have PR (Google Page Ranking) over ‘0’) 11.

After all desired Domains are added, the User can utilize Domain/Pages Management feature 12 by performing such actions as, by way of example and not as a limitation, Add or Remove custom pages 13, Track overall or Per Domain Performance 14, and Decline certain Articles scheduled to be featured or already featuring on any of the Pages for any of User's Domains 15.

Another feature available to Domain Owner is Create Automatically and Default buttons 32 available in certain areas of Domain or group Management. Create Automatically button automatically generates certain segments of the Domain/Page or Group/Page such as, by way of example and not as a limitation, Meta Tags, Title, Logo Text, Header Text, and others. This is done, by way of example and not as a limitation, through inserting the Keywords and other desired data into pre-made Text Templates stored within the System. Default button allows content of certain segments such as, by way of example and not as a limitation, Meta Tags, Title, Logo Text, Header Text, and others to their Default Values as they are recorded in corresponding Group segments. Meanwhile, the System will automatically detect and add those Pages of Domains that were not added by User, but still receive certain traffic by Internet visitors 17.

The User can also employ Accounts Receivable 18 functionality and Get Paid 19 for those Articles that were featured on User's Domains. Such payments, by way of example and not as a limitation, can be created on the basis of combining all daily Fees for all Published Articles in Paid category. It is important to note that Accounts Receivable 18 and all relevant functionality are optional for the entire System and is a feature of this particular Embodiment.

The User can also exercise Publisher Functionality 3. Through the use of 3, the User can, by way of example and not as a limitation, perform the following: Publish Article 20 by Uploading Image(s) 21, Inputting Article Text 22, Specify Article Keywords 23. While Inputting Article Text 22, the User can input text into at least two sections—Summary of Article and Body of Article. Through Direct Navigation 24 functionality, the User (Publisher) can identify what action they want the System to perform after the Internet Visitor has visited the Domain on which an Article is displayed and, for example, clicked on the Article, Article link, or Article Image. One exemplary action would be to open Body of Article on the same page of the Domain the Visitor at now. Another exemplary option is to open Body of Article outside of Domain, for example at another Domain/Site belonging to Publisher.

The User (Publisher) can also distribute any and all Articles published by him/her to any and all Domains/Pages available through the System and allowed by the System by using Distribute Article functionality 25. Publisher can perform Search For Right Domain(s) functionality 26 and filter all available Domains/Pages by such criteria as, by way of example and not as a limitation, amount of traffic, Click Through Ratio, Page Ranking, other Ratings, and find the best fit for their Article.

After Distribution research is performed and selection of Domain(s) available for Article Placement is made within functionality 26, Article is Placed at the selected Domains/Sites/Pages 27. By way of example and not as a limitation, this happens Automatically after the appropriate Fees are paid. Other embodiments may not feature Automatic calculation of Fees and Publisher will be negotiating with Domain Owner for each Placement and Place Article upon mutual agreement. Also, the whole Accounts Payable and Accounts Receivable functionality is present here by way of example and not as a limitation, and may not be featured in another embodiment, thus making Distribution process shorter and without the need of financial negotiation and financial transaction processing.

Publisher can also choose an option of Automatic Distribution 28. This functionality will automatically make certain number of Article Placements on to randomly picked Domains/Pages from the available pool.

Another important feature of the System is Limit of Article Instances 29. This feature allows limiting the number of copies of every Article across the System to a certain number.

Yet another System feature is Fee Calculation 30. In this particular embodiment, this feature allows automatically calculating the amount Publisher has to pay for every Article Placement. The Fee might be different for every Placement because every Placement is made to a different Domain/Page. Thus, the Fee is calculated based on such criteria as, by way of example and not as a limitation, Domain/Page incoming traffic, regions of incoming traffic, nature of traffic (direct, typo, secondary, etc.), average time spent by visitor on the Domain/Page, traffic relevance to Domain Keywords and/or Article Keywords, average amount of income the Domain/Page has or might be having from other sources such as PPC advertising, and others. Other options of Fee Calculating 30 not featured in this embodiment might include, by way of example and not as a limitation, Fee creation upon Auction process, Bidding process, and others and might include not only monetary equivalent but other equivalents as well such as content exchange, services exchange and any combination thereof.

The Fee may or may not be Publishing Period—based. Publishing Period is the actual time an Article Placement is scheduled to appear at a certain Domain/Page. It can be, for example, Publishing instance—based (a one-time Fee).

One more feature of the System is Permanent Or Prolonged Distribution 37. This feature allows an Article Placement once put on the Domain/Page for certain period of time become Permanently Distributed or Continually Distributed even after the payment for the Placement is exhausted or Article Placement period has expired. In this particular embodiment such Placement will be featured on the same Domain (but may or may not be at the original Page of Placement) for additional amount of time calculated on the basis of Placement's original Period (10*number of days in Placement's original Period). However, in other embodiments Permanent Or Prolonged Distribution 37 feature could display Placement permanently or for certain period of time; and on the original Domain(i)/Page(k) or on different Domain(x)/Page(y) in any combination thereof.

The System also allows Publisher to Manage Article(s) 33 by performing such actions as, by way of example and not as a limitation, Track Overall Performance 34 or Per Domain Performance 36 of Article (how many times an Article is being displayed and what actions visitors have been taken in regards to the article). As well as, by way of example and not as a limitation, Edit or Remove certain Articles that are allowed for Editing (of Image(s), Video(s), Text(s), Link(s), etc.) or Removal (of Placement(s) or an Article itself) through Edit/Remove Text/Image/Article functionality 35.

Accounts Receivable 38 functionality allows Publisher to receive reimbursements if the contract for Article Placement is bridged by no fault of Publisher. In this case, providing the amount for such Placement was already transferred to System's Escrow account, the Domain Owner will only receive the amount for the period the service were rendered and Publisher will receive total or partial Refund through Receive Refund for Declined Article or if Domain No Longer Active 39. If the contract is bridged by total or partial fault of Publisher, the Publisher might also be entitled for Total or Partial Refund. Accounts Payable feature 40 allows Publisher to make payments for certain Article Placements. The proceeds from these Payments then may be split between the System and Domain Owners in any percentage.

As would be known by anyone skilled in the relevant art, the term Internet means communication of electronic devices such as Computers, Mobile Phones, and others across digital network. The term Domain means developed or undeveloped site registered anywhere on the Internet. The term Page means any page within the Domain.

While particular elements, embodiments and applications of the present invention have been described with sufficient details, it will be understood that the invention is not limited thereto since modifications that may be done by those skilled in the art. It is thereof contemplated by the appended claims to cover such modifications as incorporate those features, which come within the scope and spirit of the present invention.

What is claimed is:

1. Method and System of distribution of digital content over the Internet across the network of Dormant Domains (Dormant Domain or Parked Domain is a domain which development is not managed by its owner, but by a Parking company) comprising:
computer servers at which information about Internet Pages belonging to multiple Domains is stored in the relational database and Page content is dynamically generated upon Internet Visitor's browser request
tools and methods by which Publisher Creates a Publisher account; Publishes (creates) at least one Article (a set of digital content consisting of, for example, text; images; links; videos); Distributes at least one Article to at least one Page which may or may not belong to Publisher/Domain Owner
tools and methods by which multiple Domain Owners can create personal accounts and add Domains into these accounts by way of entering Domain name into the System and forwarding DNS server to the System servers or by other type of referencing or forwarding; wherein the content at such Domains can consist of domain-descriptive information (such as Keywords, Description, Contact information, etc.) inputted by Domain Owner or automatically filled in by the System, and Articles.

2. A method of claim 1 wherein every Domain must belong to a certain Group. Each Group consists of domains that are servicing same specific demand.

3. A method of claim 1 wherein the System automatically
creates a website for every Domain according to Group requirements that fulfill specific demand of a given Group
fills Pages of those websites with Domain-specific content (meta keywords, meta title, meta description, etc.), which gives the Domain a better chance to be found and rated higher by Search Engines
fills Pages with content (Articles, Images, Videos, References, Links, Advertising, etc.) better satisfying specific demand for each Domain
creates additional Pages based on the Domain's prior history or current traffic and populates with Content and Advertisings; a Page-related Menu Tab may also be automatically created at the Domain Menu level;
identifies Domain Logo's characteristics such as Logo Shape, Logo Size, Logo Color, Logo Transparency, Logo Text and Text Shrift, Logo Image and Animation based on Domain's URL and Group Specifics;

4. A method of claim 1, wherein Domain Owner can track performance such as number of viewers, numbers of clicks, visitor origin, etc., as well as monetary performance (in case of paid Article Placement) of all Articles placed on any of his Pages by Publisher; and Approve or Decline any and all Articles distributed by Publishers at his Domains;

5. A method of claim 1, wherein Publisher must enter text into the Summary portion of an Article and specify whether they want a Full Article text to be displayed within the Domain the Article is assigned to or provide a reference to the Internet address where the Full Article is hosted;

6. A method of claim 1, wherein Publisher can search for all Domain Pages available to him on the System by ratings in such categories as amount of traffic, Click Through Ratio, search engine and other Rankings, traffic relevance, and others; and Place Articles at those Pages that benefit the Publisher the most;

7. A method of claim 1 wherein all Articles are served on Pages in form of Instances (copies) of the same Article. The number of Article instances must be limited across the System;

8. A method of claims 1 and 7, wherein Publisher can automatically Distribute certain amount of Article copies;

9. A method of claim 1, wherein Publisher can track performance of ALL Distributed Articles; Monitor amount of visits, amounts of visitors that clicked on an article to read more, geographical origin of visitors, visitor reviews, etc.

10. A method of claim 1, wherein Domain Owner account and Publisher account can be parts of the same account;

11. A method of claim 1 wherein Publisher can remove any Article from Distribution.

12. A method of claim 1 wherein Publisher can edit or delete any Article.

13. A method of claim 1 wherein Publisher is reimbursed in case of Paid Article Placement if a Domain or Page is no longer available on the System.
